(19) United States
(12) Patent Application Publication
(10) Pub. No.: US 2015/0199655 A1
(43) Pub. Date: Jul. 16, 2015

(54) Status Conditions of Imaging Devices for Generating Automatic Service Support

(71) Applicant: Lexmark International, Inc., Lexington, KY (US)

(72) Inventors: Peter Ginocchio Carey, Lexington, KY (US); John Matthew Mullins, Lexington, KY (US)

(73) Assignee: Lexmark International, Inc., Lexington, KY (US)

(21) Appl. No.: 14/156,539

(22) Filed: Jan. 16, 2014

(51) Int. Cl. G06Q 10/00; H04N 1/32; H04N 1/00

(52) U.S. Cl. CPC G06Q 10/20; H04N 1/00079; H04N 1/00244; H04N 1/00307; H04N 1/00477; H04N 1/32539; H04N 1/00061; H04N 1/00037

(57) ABSTRACT

A server delivers to mobile devices status conditions of imaging devices for generating automatic service support. The server receives status conditions generated by the imaging devices, determines whether they require sending to the mobile devices, and if so, delivers a notification indicating the status conditions. Mobile devices include service applications for receiving notifications from the server. Service technicians using the mobile devices automatically respond to the notifications and provide appropriate levels of service. Other embodiments note techniques for delivering the status conditions, determining which mobile devices receive will receive the notifications, and features of the service application, to name a few.

### FIELD OF THE INVENTION

The present invention relates to managed print services, and more particularly to imaging devices and mobile computing devices, such as smart phones. It further relates to applications on mobile devices that conveniently provide notifications indicating one or more status conditions of imaging devices to generate automatic service support. Associating imaging devices and mobile devices define various embodiments.

### BACKGROUND

Many modern imaging devices are capable of displaying their servicing needs on a user interface panel. Providing servicing needs to these devices such as supplies replacement and part fixtures would thus require service representatives to monitor them locally and wait for a display on the said user panel. However, monitoring the conditions of each imaging device this way provides a problem for users managing a number of imaging devices that are remotely located to each other.

In other servicing scenarios, service representatives address problems by monitoring conditions of imaging devices using external software. The software polls each imaging device at fixed intervals to determine their needs. While of limited success, polling large fleets of imaging devices in this way creates a burden on the monitoring system and increases network usage. Moreover, external software needs to be always “on” and configured correctly. It requires a certain amount of expense and can be difficult to implement or maintain.

Still, another method requires users to “subscribe” to e-mail alerts regarding conditions of their imaging devices. Whenever problems are found, an e-mail is sent to the subscribers. While e-mail is sufficient in monitoring conditions, it is not the most expedient form of digital communication. Not only can e-mails be easily dismissed, but they require organization as they may be readily confused with other e-mails in inboxes and information on the web. This wastes valuable time in knowing the status of particular imaging devices and whether they require servicing.

What is needed is a system that monitors an imaging device's condition regardless of the size of the fleet. What is also needed is a simple method of monitoring a condition of an imaging device on an at/near real-time basis and with lesser inconvenience to users. Additional benefits and alternatives are also sought when devising solutions.

### SUMMARY

The above-mentioned and other problems are solved by systems and methods involving status conditions of imaging devices requiring servicing by service technicians. In a representative embodiment, an imaging device sends its status conditions to a server. The server determines whether or not it requires servicing by a technician and, if so, delivers notice to an appropriately-paired mobile device. The mobile device comprises an operating system which hosts one or more mobile applications including a service application. The service application causes the display of the status condition of the imaging device and information thereof. The information includes make/model of the imaging device, its serial number, registered user, location, action item(s) required to resolve the condition, and the like. A positioning system on the mobile device locates the imaging device having the condition and displays it on a map. Software, executable code, interfaces, and computing system environments typify the embodiments.

Other embodiments note techniques for delivering the status conditions including associating mobile devices of the technician/s to appropriate imaging devices under their charge. Techniques include but are not limited to sending the status condition to a messaging service which converts the status condition to a format readable by the mobile device (“notification”) and in turn, delivers the notification to the mobile device. Messaging services also provide appropriate identifiers of the mobile devices that the server can assign to particular imaging devices.

These and other embodiments are set forth in the description below. Their advantages and features will become readily apparent to skilled artisans. The claims set forth particular limitations.

### BRIEF DESCRIPTION OF THE DRAWINGS

FIG. 1 is a diagrammatic view of a computing system environment for delivering status conditions of an imaging device for receiving automatic service support;

FIGS. 2A-2B are diagrammatic views of a browser displaying an activity log for monitoring the status conditions of imaging devices in a fleet, including locating the imaging devices and providing other summaries;

FIG. 3 is a diagrammatic view of a mobile device of a service technician showing components therein, including example displays of a service notification;

FIG. 4 is a flow chart showing the association of a mobile device with an imaging device for generating automatic service support thereof; and

FIG. 5 is a flow chart showing the delivery of a status condition of an imaging device to a mobile device via a messaging service.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that changes may be made without departing from the scope of the invention. The following detailed description, therefore, is not to be taken in a limiting sense and the scope of the invention is defined only by the appended claims and their equivalents. In accordance with the features of the invention, systems and methods for delivering status conditions of imaging devices for generating automatic service support are described herein.

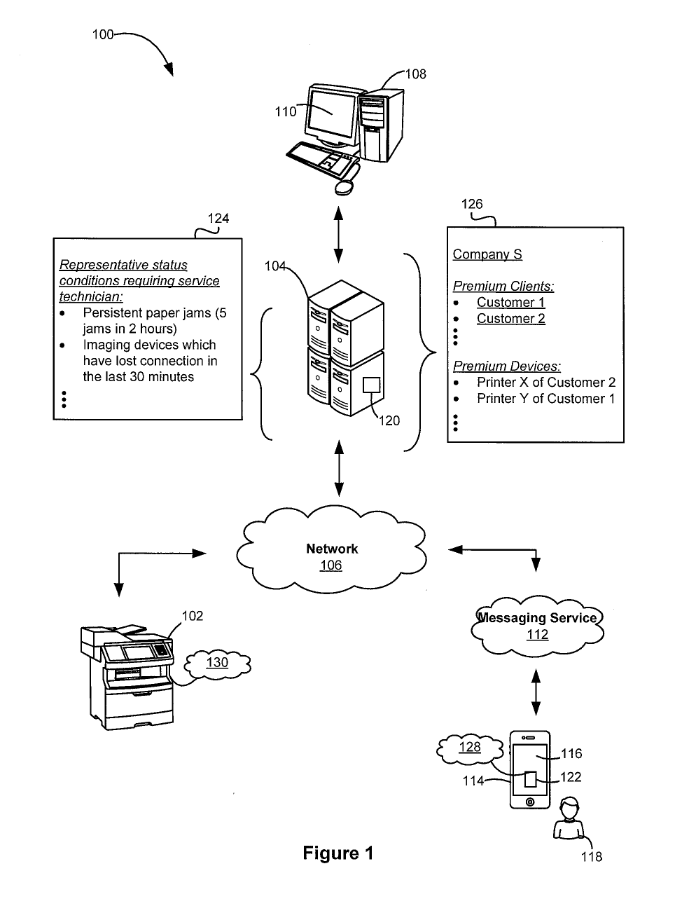

With reference to FIG. 1, system 100 for delivering a status condition of an imaging device to a mobile device includes an imaging device 102 which sends its generated status conditions to server 104 through network 106. Imaging device 102 is registered to system 100 and may be part of a group of one or more imaging devices (“fleet”). Server 104 may provide the status condition(s) of imaging device 102 to a client device 108 for display on browser 110. Browser 110 may communicate with server 104 to provide an at/near real-time display of the status condition(s) from one or more imaging devices, such as imaging device 102. Server 104 then determines which of the status conditions received from imaging device 102 are to be sent to a mobile device for automatic service support. Upon determination of these status conditions, server 104 forwards these same conditions to messaging service 112 for conversion and delivery to mobile device 114 which displays the status condition on its user interface 116. User 118 of mobile device 114 receiving the converted status condition or notification may be a user of imaging device 102, a service technician assigned to provide assistance to imaging device 102, a company managing one or more imaging devices, or the like. The company may need a system such as that of system 100. User 118 may also be a client of the company having one or more imaging devices.

Executable code 120 such as in a controller, microprocessor, Application-Specific Integrated Circuit (ASIC), etc., in server 104 assists in determining which of the status conditions received from imaging device 102 requires the assistance of a service technician. Status conditions refer to events normally generated by an imaging device, such as printing a number of n pages, opening and closing of a cover of the imaging device, loading of paper trays, toner cartridge errors, paper jams, and the like. Status conditions in an imaging device that require the assistance of a service technician include toner cartridge replacements, persistent paper jams, and printer connection problems, to name a few. Status conditions may also include events which require assistance of a service technician as part of a set of terms predetermined by user 118 if user 118 is not the service technician. A database record having these status conditions may be referred to by server 104. Record 124 shows representative status conditions requiring assistance of a service technician.

The frequency of each status condition, as they are sent by the imaging devices, may also be monitored by server 104 to determine the severity of the status condition. Once a certain status condition's frequency reaches a threshold value or a percentage relative to the normal operation of imaging device 102, the said status condition is sent from server 104 to messaging service 112 for conversion and delivery to mobile device 114. This way, user 118 is notified of the status condition of the one or more imaging devices before the status conditions become more persistent and cause more problems (“preemptive” notification). The threshold value and the status conditions to be sent may be configured by user 118 using browser 110 or may be predetermined upon registration of imaging device 102 to system 100. Server 104 may be able to determine the status conditions requiring immediate assistance of a service technician. Alternatively, automatic service support may come in the form of status conditions that show a component that recently broke or a faulty operation therein such as failure to perform a scan or a fax operation (“already broken” notification). Skilled artisans can think of other status conditions which would require immediate assistance of the technician.

In the case where user 118 is a company managing a fleet of imaging devices each managed by respective clients, server 104 may include record 126 of clients who opted to receive the status condition of the imaging device(s) they manage (e.g. “premium client”). Record 126 may also include selected imaging devices (e.g. “premium device”) under management of a premium client that the premium client wishes to know the status condition of. A premium client may have at least one premium device. For example, once a “premium client” or a “premium device” is determined by server 104, the status condition(s) of the premium device(s) under the premium client are sent to messaging service 112 for conversion and delivery to mobile device 114 on an at/near real-time basis or at a chosen interval. Given that each client has a profile (e.g. an “account’) under management of user 118, each premium client may be charged at a certain amount for the generation of automatic service support, the implementation of system 100, and/or the continual tracking and analysis of the status conditions, as is typical in a managed print services scenario. Non-premium clients continue to operate their one or more imaging devices and would not get automatic service support for those devices unless they sign up for system 100.

Status conditions sent by imaging device 102 may be stored on server 104 or on another remote storage for generating servicing reports which may be retrieved and/or referred to by user 118 at a certain period, such as weekly or monthly. Server 104 may also include action items corresponding to each status condition received from the imaging devices such as imaging device 102. Server 104 may determine the action item required for each status condition received that requires assistance of a service technician and send the action item required to messaging service 112 together with the status condition. An action item may be a site visit and/or a phone call by a service representative or technician. Other types of action items may be apparent to those skilled in the art of servicing. A site visit may be provided as an action item for a toner cartridge replacement, for example. A phone call may be provided whenever, for example, the service technician's location is very far from the imaging device in need of servicing or whenever its status condition is determined to be uncritical and can be solved through troubleshooting by the owner of the imaging device. These action items may be predetermined by user 118 and may be dependent on the severity of the status condition based on the frequency value. Other example embodiments of scenarios are apparent to skilled artisans.

Messaging service 112 is a third-party messaging service that communicates with server 104 for the status condition to be converted and delivered as a notification to mobile device 114. Messaging service 112 may include another server and/or still other computing devices for facilitating the conversion and delivery of the status condition of imaging device 102. Furthermore, messaging service 112 may be dependent on an operating system of mobile device 114. For example, Google Cloud Messaging (GCM) and Apple Push Notifications Service (APNS) may be utilized for mobile devices hosted by Android™ and Apple® operating system, respectively.

Mobile device 114 is any computing device that is portable, handheld, or pocket-sized such as a smart phone, a handheld computer, a personal digital assistant (PDA), a notebook computer, a tablet computer, or any other remote computing device, such as a special-purpose remote computing device (e.g. an e-book reader). It is communicatively coupled with server 104 through a service application primarily residing as executable code 120 in server 104, in client device 108, or imprinted on a computer readable medium such as a CD, smart card, USB stick, or etc., that gets installed directly in the mobile device, as is typical. In this example embodiment, user 118 may download executable code 120 onto mobile device 114 for installation therein, resulting in service application 122. Service application 122 then requests registration identifier 128 from messaging service 112. A representative registration identifier may be a string of alphanumeric characters of varying length such as r3G1D3n7if13r. Messaging service 112 issues registration identifier 128 to service application 122 and service application 122 sends or pushes it to server 104. Upon receipt, server 104 uses registration identifier 128 for assigning mobile devices 114 to imaging devices 102. Imaging devices 102 are uniquely identified to the mobile devices such as by their Internet Protocol (IP) address, MAC address, or serial number 130 (e.g. “123PTB456789”) of imaging device 102. In this way, unique mobile devices of service technicians are directly paired or tied to imaging devices in need of service, as will be described in more detail below. Of course, other kinds of identifiers for assigning mobile device 114 to imaging device 102 may be apparent to those skilled in the art. Upon association of mobile device 114 to imaging device 102, mobile device 114 receives and displays the notification on user interface 116 of mobile device 114 indicating the status condition of assigned imaging device 102.

Network 106 may be any Internet Protocol (IP) based computer network capable of communicating data and other information between imaging device 102, server 104, and mobile device 114. Network 106 may comprise a Local Area Network (LAN) or a wide area network (WAN) (e.g. Internet), and may be a public or a private network. Network 106 may use any communication medium, such as cable, optical fiber, radio carriers, etc., or any combination thereof, to communicate with imaging device 102, server 104, and mobile device 114. Network 106 may include a variety of software such as an “app store” and hardware such as routers, servers, switches, desktop/laptop computers, phone transmission towers, satellites, etc. Skilled artisans know the process and appropriate environment for downloading applications and associating the devices in network 106.

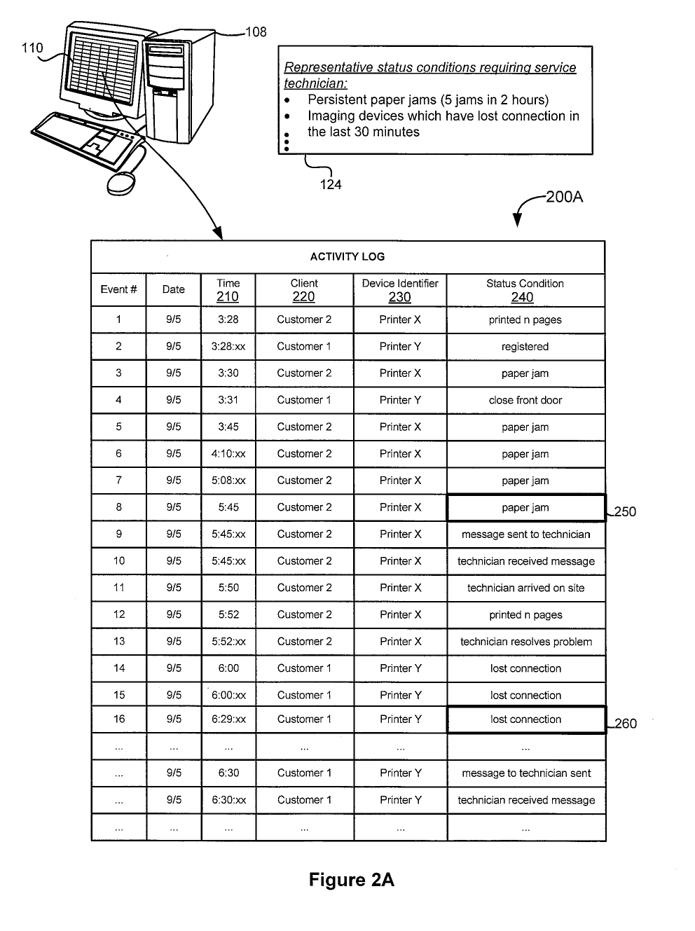

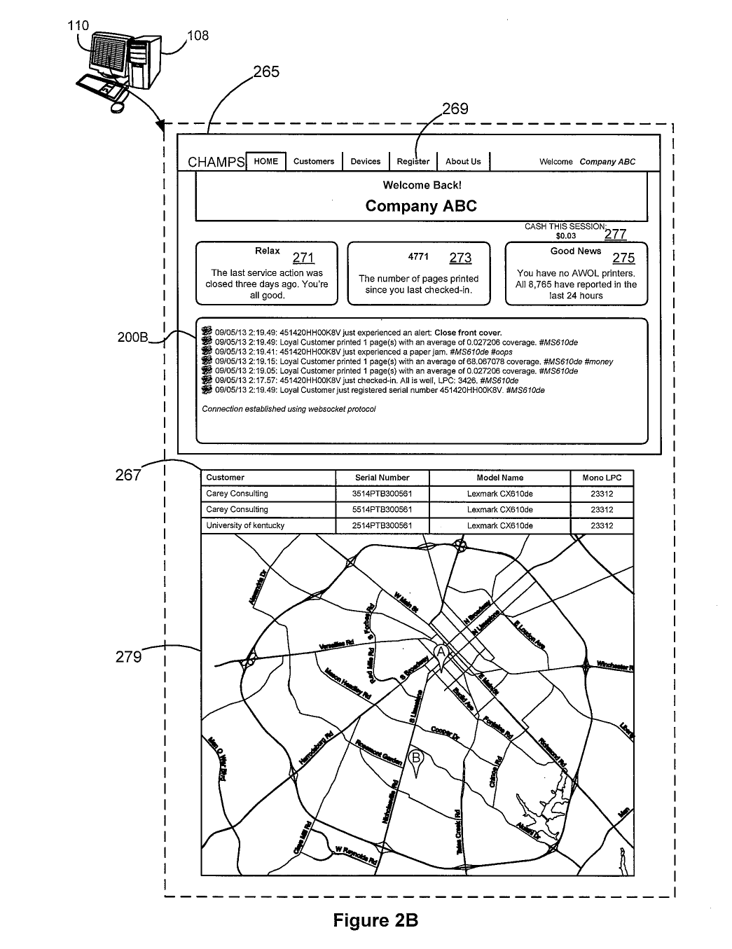

With reference to FIG. 2A, activity log 200A displayed in browser 110 of imaging device 108 shows the status conditions generated by one or more imaging devices such as imaging device 102 of FIG. 1. An application on browser 110 may be launched to provide activity log 200A for displaying the status conditions retrieved from server 104. Browser 110 may be a web browser and may be communicatively coupled with server 104 through the websocket protocol or any other communications channels wherein data is passed back and forth between browser 110 and server 104. This way, any data, including the status condition and information relating to imaging device 102, that is received by server 104 is instantly passed on to browser 110 for display at or near real-time in activity log 200A. Status conditions collected by server 104 from the one or more imaging devices may be passed on to browser 110 upon launching of the activity log 200A. Browser 110 may be one or more browsers dispersed throughout network 106 for displaying the status conditions of imaging device 102. It may be understandable for those skilled in the art that other protocols or techniques may be executed to retrieve and display the status conditions in network 106 for automatic service support.

Activity log 200A includes exemplary status conditions 240 and may further include columns containing the time stamp 210 the status condition transpired, client 220 managing the imaging device having the status condition, device identifier 230, and a chronological organizer of conditions thereof (e.g. event numbers). Particular status conditions such as persistent paper jams (250) and imaging devices which have lost their connection in the last 30 minutes (260) are representative items requiring assistance of a service technician as determined by server 104 or other computing systems. For status condition 250, paper jams have been occurring irregularly between times 3:30 and 5:45, as seen, and server 104 has determined this to be so frequent as to require assistance of a service technician based on record 124. For status condition 260, on the other hand, printer Y of Customer 1 has lost its connection to system 100 for more than an hour and requires servicing by a service technician. Server 104 then determines the particular mobile device/s associated with each of printers X and Y. Upon determining that mobile device 114 is associated with printer X, for example, server 104 packages status condition 250 including information regarding printer X for delivery to messaging service 112. Messaging service 112 receives status condition 250 and information of printer X and converts these to a notification for display on mobile device 114 of the service technician, as seen at times 5:45:xx and 6:30:xx. When it has been determined by server 104 that the imaging devices in need of servicing have stopped generating the status conditions such as 250 and 260, such is indicated in activity log 200A that the service technician has resolved the problem. Of course, these are only some of the types of status conditions requiring notice of a service technician. Other types of status conditions of imaging devices and techniques of displaying a real-time activity log of the automatic service support processes are apparent to those skilled in the art.

With reference to FIG. 2B, activity log 200B may be paired with other summaries and description of items in the computing system environment. For example, FIG. 2B shows summary pages 265, 267 paired with activity log 200B and exemplifies actual embodiments of an activity log and other reports for system 100 that have been actually reduced to practice by the inventors. Summary page 265 includes activity log 200B and “tabs” having different functionalities. Tab 269 serves as a link for a registration page wherein imaging device 102 (FIG. 1) may be registered by user 118 having an account (“Champs”) on system 100 of FIG. 1. Tabs 271, 273, and 275 provide an update of the last service action executed, the total number of n pages printed for imaging device 102, and the number of printers connected to system 100 in the last n hours, respectively. Amount 277 displays the total cash acquired for the services rendered by the service technician, number of n pages printed for each imaging device 102, etc. In this scenario, amount 277 pertains to cash acquired for the three pages printed by an imaging device Loyal Customer at times 2:19:15, 2:19:05 and 2:19:49, as displayed by activity log 200B. It may be apparent to skilled artisans that the activity log may stream real-time updates on status conditions for each imaging device connected to system 100, such as imaging device 102. Similarly, summary page 267 displays a list of the one or more imaging devices registered to system 100 and locations thereof. A map 279 in browser 110 displays the locations of the one or more imaging devices, such that a user who monitors activity log 200B will be aware of the positioning of imaging devices registered to the system. Skilled artisans will recognize that the activity logs 200A and 200B in browser 110 may be configured to display other information preferred by user 118 in monitoring the status conditions of the imaging device/s.

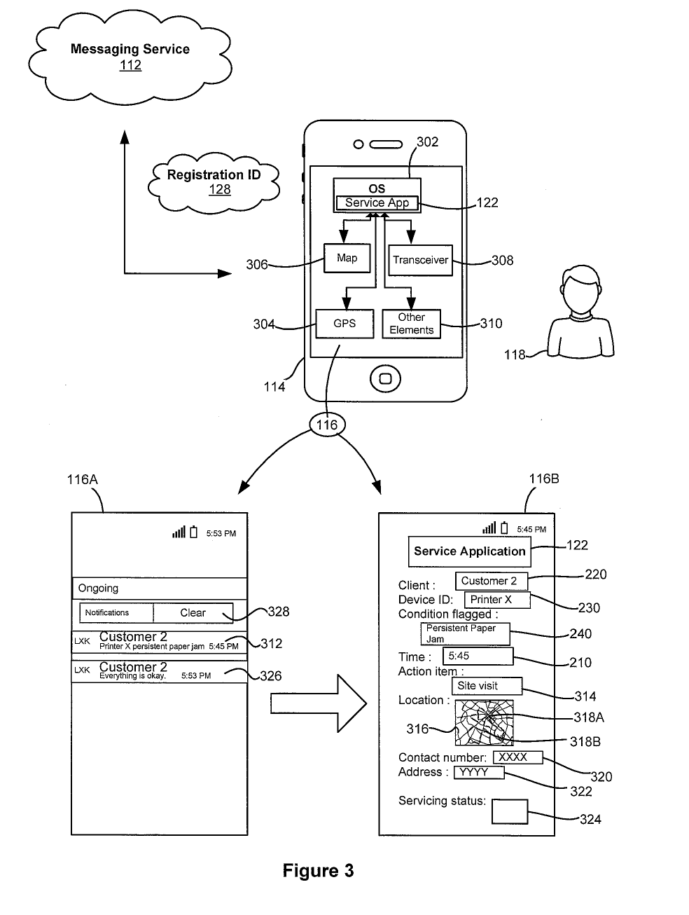

With reference to FIG. 3, mobile device 114 is shown to be communicatively connected to messaging service 112. It includes one or more components such as, for example, operating system 302, global positioning system (GPS) 304, mapping function 306, transceiver 308, and other elements 310 which may be accessed by user 118 (e.g. service technician). Operating system 302 of mobile device 114 hosts service application 122 and one or more mobile applications, as is typical. Global positioning system (GPS) 304 also resides in mobile device 114 and communicates with service application 122 to locate imaging device 102 generating the status condition. It is integrated in mobile devices, especially smart phones, to establish its whereabouts at all times. GPS 304 may be used to establish whereabouts of a location or position that is not necessarily the current location of mobile device 114, such as neighboring landmarks. The location of the mobile device may be displayed on a map through a mapping function 306 that also communicates with service application 122. The unit of measurement of the positioning system is any of a variety recognizable by the service application but coordinates from a GPS (global positioning satellite) module are typical. These include but are not limited to absolute locations such as latitude/longitude and altitude coordinates about the world, relative locations noted by “pin drops” or other designators such as flags, stars, etc. placed on maps from the mapping function 306.

A transceiver 308 also resides in mobile device 114 to communicate information from service application 122 to messaging service 112 or to any other device, such as another mobile device 114. At other elements 310, the service application 122 leverages still other modules and functionalities of mobile device 114. This includes but is not limited to functions found in address books, lists of contacts, calendars, clocks, cameras, photos, notifications, messages, compasses, push notifications, etc. Other modules and functionalities in mobile devices are apparent to those skilled in the art.

With continued reference to FIG. 3, the service application 122 causes display of the notification on user interface 116 of mobile device 114. The notification is as simple or complex as necessary to identify the status condition of imaging device 102 in a manner suitable for servicing. Mobile device 114 may be associated with imaging device 102 (FIG. 1) when server 104 assigns registration identifier 128 received from service application 122 of the mobile device with an identifier, such as serial number 130 of imaging device 102, as described above. User interface 116A shows an example display when a notification indicating the status condition of an imaging device has been received. For this representative embodiment, notification 312 is received citing a status condition of Printer X of Customer 2 that requires servicing of a technician (e.g. persistent paper jam 250 of FIG. 2A). Notification 312 received from messaging service 112 automatically appears on user interface 116A without opening service application 122 installed on mobile device 114. When notification 312 is chosen, such as touched, on user interface 116A, service application is launched on user interface 116B which shows further details of notification 312. The details correspond to client 220, device identifier 230, status condition 240 thereof, time stamp 210 the status condition transpired, action item required 314 to resolve the status condition, map 316 of the imaging device comprising locators 318A and 318B for the locations of the imaging device in need of servicing and the mobile device respectively, and the client's contact details such as contact number 320 and address 322. User interface 116B may also include button 324 to enable user 118 to enter data on the progress of the service call or that the servicing is complete.

With further reference back to FIG. 2A, status condition 250 appears as a notification displayed in user interface 116B. Since Printer X of Customer 2 experiences persistent paper jams, notification 312 is sent to Customer 2 which cites “Customer 2” as the client, “Printer X” as the device identifier, “persistent paper jam” as the condition flagged, “5:45:xx” as time the status condition transpired, “XXXX” as contact number 320 of Customer 2, and “YYYY” as the address 322 of Customer 2. Notification 312 also includes map 316 showing locator 318A for the location of Printer X and/or locator 318B for the current location of mobile device 114. Location of Printer X may be its location as it was registered. The current location of mobile device 114 meanwhile may be established by GPS 304 and may be a location or position that is not necessarily the current location of mobile device 114. Contact number 320 may be a cellphone number, a home landline number, or a work phone number, while address 322 may be a home address or an office address; both may depend on what was provided by Customer 2 during registration to system 100.

User interface 116 of mobile device 114 may be a touch screen display in which hand gestures are applied by user 118. Hand gestures can take the form of hook-and-drag, tap and double-tap, swipe or other gestures recognized by the service application. In another embodiment, service application 122 may send a message to server 102 (FIG. 1) indicating that the issue is being solved when it has determined that the service technician is physically nearby the imaging device having the status condition through determining the current location of mobile device 114. In other words, if mobile device 114 is determined to be “close” to the location of the imaging device needing servicing, service application 122 automatically sends a message to server 104 that a service call is being undertaken. Alternatively, server 104 may also send another notification to mobile device 114 when it has determined that imaging device 102 in need of servicing stopped generating the status condition and that the servicing is indeed complete. If server 104 has determined that the servicing is complete, service application 122 may automatically delete the notification on mobile device 114. User 118 may also clear user interface 116A by deleting the notifications received using button 328. Upon determination of server 104 that the service call is completed or no new status conditions have been received by the service application, server 104 may send another notification to mobile device 114 such as that of notification 326 citing “Everything is OK” for Customer 2, for example. Of course, other functionalities and applications installed on mobile device 114 may provide a display on user interface 116, such as the date, time, and the weather, as is typical in a user interface of a mobile device. Other alternative embodiments are also apparent to those skilled in the art.

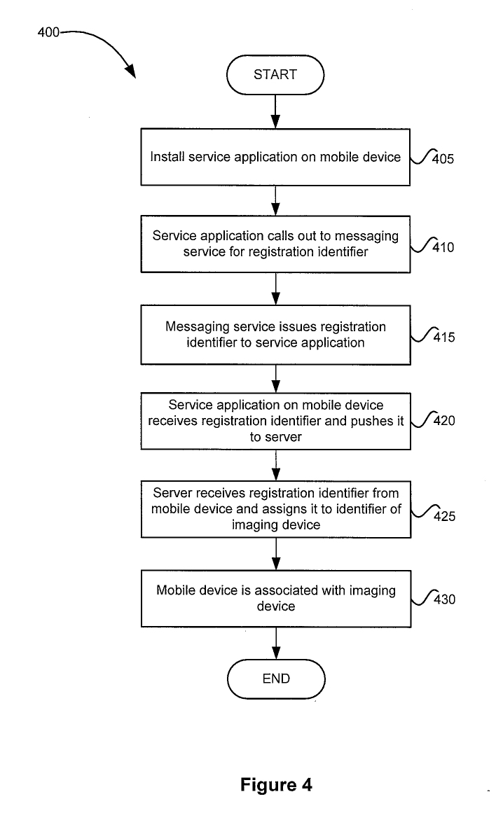

With reference to FIG. 4, flowchart 400 shows one example method of associating the mobile device with at least one imaging device of system 100 in FIG. 1. At 405, service application (122) is installed on mobile device (114). Installation is performed to receive notifications indicating the status condition of the imaging device in need of servicing and other details of the status condition of the imaging device. Upon successful installation, service application (122) then calls out to messaging service (112) for registration identifier (128) at 410. At 415, messaging service (112) then issues registration identifier (128) to tie service application (122) with the mobile device, as seen at 410. At 420, service application (122) on mobile device (114) receives the registration identifier from messaging service (112) and pushes it to server (104). At 425, server (104) receives the registration identifier from mobile device (114) and assigns it to an identifier of particular imaging device (102). In this way, unique mobile devices (114) are paired with particular imaging devices (102) and are enabled to receive the status conditions thereof, as seen at 430. Server (104) may assign serial number (130) of imaging device (102) with registration identifier (128) of mobile device (116). When it is determined by server (104) that the status condition of imaging device (102) is configured to be sent to mobile device (114), the status condition is sent to mobile device (114) associated therewith, as well as other information relating to imaging device (102).

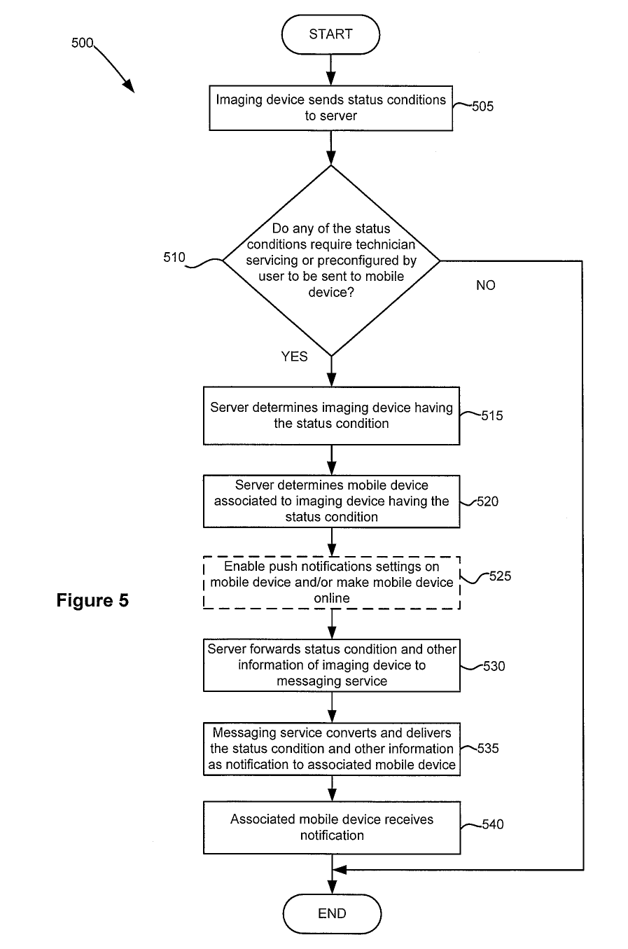

With reference to FIG. 5, flowchart 500 presents one example method of delivering a status condition of an imaging device to a mobile device via a messaging service for generating automatic service support. At 505, imaging device (102) sends status conditions to server (104) upon the occurrence of the status condition to provide at or near real-time updates of its status condition. For instance, as displayed in activity log 200A of FIG. 2A, Printers X and Y of Customers 1 and 2 respectively send status conditions such as pages printed and a paper jam. At 510, server (104) determines if the status condition received from imaging device (102) requires assistance by a service technician or if it is preconfigured to be sent to the mobile device (116). Upon a positive determination for either of the two conditions, server (104) then determines which particular imaging device (102) has the said condition at 515 and which particular mobile device/s requires notice.

Referring back again to activity log 200A of FIG. 2A, since Printer X is a premium device of premium client Customer 2 and the frequency of status condition 250 has exceeded the threshold value of five in the last two hours for paper jams, status condition 250 is configured to be sent to the mobile device of the assigned technician, which is mobile device (116) for this example embodiment. Other techniques in filtering the status conditions to be displayed on activity log 200A and/or sent to mobile device (116) are apparent to skilled artisans. Meanwhile, upon determining that none of the conditions in 510 have been satisfied, server (104) waits for the next status condition/s to be sent by imaging device (102) as seen at 505. At 515, server (104) determines the imaging device having the status condition. At 520, server (104) then determines the mobile device (114) associated with the imaging device in need of servicing.

In some cases in installing applications on both Android™ and Apple® devices, receiving notifications from mobile devices are restricted as a default setting; thus, push notification settings on mobile device (114) require to be enabled in order to receive the notifications and/or the mobile device to be online, as shown in optional step 525. To address this, server (104) determines whether the push notification settings were enabled and/or whether mobile device (114) is online prior to forwarding the status condition to the messaging service, as shown in optional step 525. Upon determining such, server (104) forwards the status condition and other information on imaging device (102) to messaging service (112), as seen at 530. Messaging service (112) then converts and delivers the status condition as a notification (530) for displaying on the associated mobile device at 535. At 540, associated mobile device (114) receives the notification as a display on its user interface as seen in 116A and 116B of FIG. 3, for example.

In another aspect, responding to the notification indicating the status condition of one or more imaging devices is done by a service call, such as a site visit and/or a phone call by the service technician. For example, upon receiving the notification, service technician goes to the location of the imaging device having the status condition as indicated in the notification while the server constantly determines his location by referencing GPS location of mobile device pushed to the server by the service application. Alternatively, the service technician may contact the user managing the imaging device through the contact details displayed in the notification and help in troubleshooting the status condition of the imaging device over the phone. A server also determines if the status condition is actually resolved by monitoring the status conditions in the activity log.

Relative advantages of the many embodiments should now be apparent to skilled artisans. They include but are not limited to: (1) providing a method of delivering a condition from an imaging device to a mobile device at or near real-time; (2) associating a mobile device and an imaging device in a network (3) providing an efficient method of monitoring status conditions of imaging devices under management of a user in a fleet, and (4) generating immediate and automatic service support to a preemptive and “already broken” status conditions of imaging devices.

The foregoing illustrates various aspects of the invention. It is not intended to be exhaustive. Rather, it is chosen to provide the best illustration of the principles of the invention and its practical application to enable one of ordinary skill in the art to utilize the invention. All modifications and variations are contemplated within the scope of the invention as determined by the appended claims. Relatively apparent modifications include combining one or more features of various embodiments with features of other embodiments.

1. A method of delivering notice to a mobile device of a service technician indicating a status condition of an imaging device requiring servicing, comprising:
receiving at a server connected to the imaging device the status condition generated by the imaging device;
determining whether the status condition requires servicing or not by the service technician; and
upon a positive determination, delivering a notification from the server to the mobile device indicating the status condition of the imaging device.

2. The method of claim 1, further including determining whether the status condition corresponds to a condition preconfigured by a user of the imaging device to be delivered to the mobile device.

3. The method of claim 1, further including delivering the notification using a messaging service.

4. The method of claim 1, further including identifying which mobile device of the service technician is associated with the imaging device generating the status condition requiring servicing.

5. The method of claim 1, further including associating the imaging device with the mobile device including storing a registration identifier of the mobile device of the service technician and assigning the imaging device to the registration identifier.

6. The method of claim 5, wherein the storing the registration identifier of the mobile device of the service technician includes installing a service application on the mobile device and receiving the registration identifier corresponding to the service application installed on the mobile device.

7. A server for connection to an imaging device and a mobile device of a service technician for generating automatic service support for the imaging device, comprising a controller having executable instructions configured to:
receive from the imaging device a status condition generated by the imaging device;
determine whether the status condition requires servicing or not by a service technician; and
upon a positive determination, deliver the status condition as a notification to the mobile device using a messaging service.

8. The server of claim 7, wherein the controller is further configured to identify which mobile device of the service technician is associated with the imaging device generating the status condition.

9. The server of claim 7, further including executable instructions available for download and installation on the mobile device as a service application.

10. The server of claim 9, wherein the controller is further configured to receive a registration identifier corresponding to the service application installed on the mobile device of the service technician.

11. The server of claim 10, wherein the controller is further configured to associate the imaging device with the mobile device of the service technician including to store the registration identifier and to assign the imaging device to the registration identifier corresponding to the service application installed on the mobile device of the service technician.

12. The server of claim 7, wherein the controller is further configured, to determine whether the status condition corresponds to a condition preconfigured by a user of the imaging device to be delivered to the mobile device of the service technician.

13. A system for generating automatic notification for an imaging device by messaging to a mobile device of a service technician, comprising:
one or more imaging devices generating a plurality of status conditions requiring service;
one or more mobile devices associated with the one or more imaging devices; and
a server in electronic communication with the one or more imaging devices and the one or more mobile devices, the server operative to
receive the plurality of status conditions generated by the one or more imaging devices,
determine whether any status condition of the plurality of status conditions is one requiring servicing by the service technician, and
upon a positive determination, deliver the status condition as a notification to at least one of the one or more mobile devices,
wherein the at least one of the one or more mobile devices is operative to display the notification to identify a particular imaging device associated with the status condition and the status condition thereof.

14. The system of claim 13, wherein the one or more mobile devices include a service application installed thereon for receiving the notification.

15. The system of claim 13, wherein the server is further operative to determine whether the status condition of the plurality of status conditions corresponds to a status condition preconfigured by a user of the particular imaging device to be delivered to the at least one of the one or more mobile devices.

16. The system of claim 13, wherein the server is further operative to identify which mobile device of the one or more mobile devices is associated with the particular imaging device to which the status condition is configured to be sent.

17. The system of claim 13, wherein the server further includes executable instructions available for download and installation on the at least one of the one or more mobile devices as a service application.

18. The system of claim 17, wherein the server is further operative to receive a registration identifier corresponding to the service application installed on the at least one of the one or more mobile devices.

19. The system of claim 18, wherein the server is further operative to associate at least one of the one or more imaging devices with the at least one of the one or more mobile devices including to store the registration identifier and to assign the at least one of the one or more imaging devices to the registration identifier corresponding to the service application installed on the at least one of the one or more mobile devices.

20. The system of claim 11, further comprising a messaging service in electronic communication with the at least one of the one or more mobile devices and the server, wherein the status condition is delivered as the notification using the messaging service.
